(19) United States
(12) Patent Application Publication
(10) Pub. No.: US 2020/0310124 A1
(43) Pub. Date: Oct. 1, 2020

(54) HEAD MOUNTED DISPLAY DEVICE AND BACKLIGHT APPARATUS THEREOF

(71) Applicant: HTC Corporation, Taoyuan City (TW)

(72) Inventors: Iok Kan Choi, Taoyuan City (TW); Po-Sen Yang, Taoyuan City (TW); Shiang-Ting Wan, Taoyuan City (TW); Yu-Heng Chen, Taoyuan City (TW); Ling-Yi Ding, Taoyuan City (TW)

(73) Assignee: HTC Corporation, Taoyuan City (TW)

(21) Appl. No.: 16/744,183

(22) Filed: Jan. 16, 2020

Related U.S. Application Data
(60) Provisional application No. 62/825,031, filed on Mar. 28, 2019.

(51) Int. Cl. G02B 27/01; F21V 8/00

(52) U.S. Cl. CPC G02B 27/0172; G02B 2027/0118; G02B 6/0053

(57) ABSTRACT

A head mounted display device and a backlight apparatus are provided. The backlight apparatus is adapted for the head mounted display device. The backlight apparatus includes a light guiding component, a light source, and a prism structure. The light source is disposed on a side of the light guiding component. The prism structure has a first surface adjacent to a first surface of the light guiding component. There are a plurality of convex pyramids on the first surface of the prism structure. The pyramids are arranged in an array.

### CROSS-REFERENCE TO RELATED APPLICATION

This application claims the priority benefit of U.S. provisional application Ser. No. 62/825,031, filed on Mar. 28, 2019. The entirety of the above-mentioned patent application is hereby incorporated by reference herein and made a part of this specification.

### BACKGROUND

### Technical Field

The disclosure relates to a head mounted display device and a backlight apparatus thereof, and in particular to a head mounted display device and a backlight apparatus capable of providing a collimated backlight beam.

### Description of Related Art

With the advancement of electronic technology, it has become a trend to provide a high-quality vision system in an electronic device. In recent years, the display technology of virtual reality and augmented reality applied to high-quality stereoscopic images of a head mounted display device has become a new trend.

The head mounted display device may generate a beam through a backlight apparatus and an image beam is generated together with a display panel, so that the image beam may be projected to the user to generate visual effects. In the prior art, the beam generation method of the backlight apparatus may be divided into two types: direct type and side-incident type. However, no matter which generation method is used, each beam projected by the conventional backlight apparatus is widely dispersed and is projected with a relatively large viewing angle. As a result, the brightness provided by the conventional backlight beam is limited. If an image beam of sufficiently bright brightness is to be generated, the driving current of the backlight apparatus needs to be increased, causing power consumption.

### SUMMARY

The disclosure provides a head mounted display device and a backlight apparatus thereof, which can provide a collimated backlight beam and improve the brightness of a display image.

The backlight apparatus of the disclosure is adapted for a head mounted display device. The backlight apparatus includes a light guiding component, a light source, and a prism structure. The light source is disposed on a side of the light guiding component. The prism structure has a first surface adjacent to a first surface of the light guiding component. There are a plurality of convex pyramids on the first surface of the prism structure. The pyramids are arranged in an array.

The head mounted display device of the disclosure includes a display panel, a lens set, and the backlight apparatus as described above. The lens set is disposed on an outside of a first surface of the display panel. The backlight apparatus is disposed on an outside of a second surface of the display panel. The first surface of the display panel is opposite to the second surface of the display panel.

Based on the above, the backlight apparatus of the disclosure enables the beam generated by the backlight apparatus to have a light-concentrating effect through disposing the plurality of convex pyramids on the prism structure. The head mounted display device of the disclosure can effectively improve the brightness of the display beam and reduce power consumption through the prism structure having the convex pyramids.

To make the aforementioned and other features of the disclosure more comprehensible, several embodiments accompanied with drawings are described in detail as follows.

### BRIEF DESCRIPTION OF THE DRAWINGS

FIG. 1 is a schematic diagram of a backlight apparatus according to an embodiment of the disclosure.

FIG. 2 is a schematic diagram of a head mounted display device according to an embodiment of the disclosure.

FIG. 3A and FIG. 3B are schematic diagrams of implementing a pyramid of a prism structure according to an embodiment of the disclosure.

FIG. 4 is a cross-sectional structure diagram of a backlight apparatus according to another embodiment of the disclosure.

FIG. 5A and FIG. 5B are respectively distribution diagrams of emission angles of sub beams generated by a backlight apparatus according to an embodiment of the disclosure.

### DETAILED DESCRIPTION OF DISCLOSED EMBODIMENTS

Please refer to FIG. 1. FIG. 1 is a schematic diagram of a backlight apparatus according to an embodiment of the disclosure. A backlight apparatus 100 includes a light guiding component 110, a light source 120, and a prism structure 130. In the embodiment, the backlight apparatus 100 is a side-incident type backlight apparatus. The light source 120 is disposed on a side of the light guiding component 110. The light source 120 generates source beams LS1 and LS2, and transmits the source beams LS1 and LS2 to the light guiding component 110. The light guiding component 110 enables the source beams LS1 and LS2 to generate one or more reflection actions, and beams LS1′ and LS2′ are emitted from a first surface SF11 of the light guiding component 110.

In the embodiment, the first surface SF11 of the light guiding component 110 is coupled to the prism structure 130. The prism structure 130 has a plurality of convex pyramids 131 to 13N on the first surface SF13. The pyramids 131 to 13N may be arranged in an array on a first surface SF13 of the prism structure 130 and are in contact with the first surface SF11 of the light guiding component 110.

The beams LS1′ and LS2′ are projected onto the pyramids 131 to 13N and a plurality of beams LB1 and LB2 may be generated on a second surface SF14 of the prism structure 130 through the refraction action of the pyramids 131 to 13N, wherein the second surface SF14 and the first surface SF13 of the prism structure 130 are two opposite sides. In the embodiment, in the application of the head mounted display device, the beams LB1 and LB2 may be used as a backlight beam and projected onto a display panel to generate an image beam.

It should be noted that, in the embodiment, each of the beams LB1 and LB2 may include a plurality of sub beams. Through the refraction action of the pyramids 131 to 13N, the plurality of sub beams included in each beam (take the beam LB1 as an example) may produce a mutual concentration effect. Specifically, the emission angles of the plurality of sub beams included in each beam may be limited to less than a reference value. In this way, the brightness of each beam can be effectively improved.

In addition, the light source 120 according to the embodiment of the disclosure may be a light emitting diode or may be constructed from other types of various light emitting components.

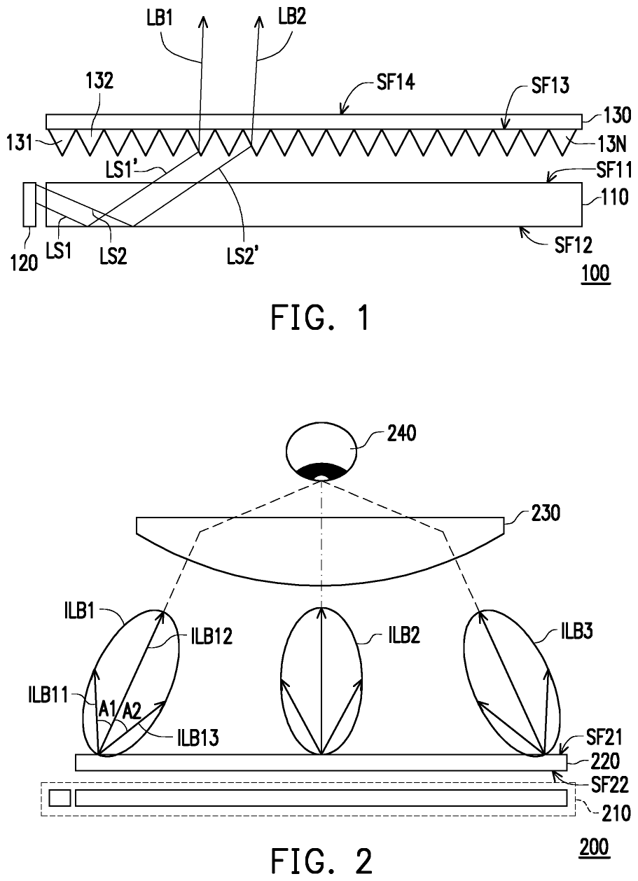

Please refer to FIG. 2. FIG. 2 is a schematic diagram of a head mounted display device according to an embodiment of the disclosure. A head mounted display device 200 includes a backlight apparatus 210, a display panel 220, and a lens set 230. In the embodiment, the lens set 230, the display panel 220, and the backlight apparatus 210 are sequentially disposed. The lens set 230 may be disposed on an outside of a first surface SF21 of the display panel 220 and the backlight apparatus 210 may be disposed on an outside of a second surface SF22 of the display panel 220. The backlight apparatus 210 may be implemented by applying the backlight apparatus 100 of the above embodiment. Beams (for example, beams LB1 and LB2) emitted by the backlight apparatus 210 are transmitted to the display panel 220, which enables the display panel 220 to correspondingly generate a plurality of image beams ILB1 to ILB3. The image beams ILB1 to ILB3 are projected onto the lens set 230 and are transmitted to a user 240 through the refraction action of the lens set 230, so as to generate a visual effect.

In FIG. 2, the image beam ILB1 is taken as an example. Based on the beam emitted by the backlight apparatus 210, the correspondingly generated image beam ILB1 includes a plurality of sub image beams ILB11 to ILB13. The included angle between the emission angles of the sub image beams ILB11 and ILB12 is an angle A1, and the included angle between the emission angles of the sub image beams ILB12 and ILB13 is an angle A2, wherein the angle A1+A2 is less than a reference value. The reference value is, for example, 10 degrees. Taking the sub image beam ILB12 as the center sub image beam as an example, the angles A1 and A2 may be not greater than 5 degrees.

In this way, the emission range of the image beams ILB1 to ILB3 can be concentrated and the brightness can be effectively improved. Under the premise that the brightness of the image beams ILB1 to ILB3 can be effectively improved, the power consumption required by the backlight apparatus 210 can also be effectively reduced to achieve power saving.

In addition, through concentrating the emission range of the image beams ILB1 to ILB3, stray light generated in the display image can be effectively reduced, thereby reducing the situation of a ghost image generated in the image.

In the embodiment, the lens set 230 may be composed of one or more lenses of the same type or different types, and there is no fixed limit.

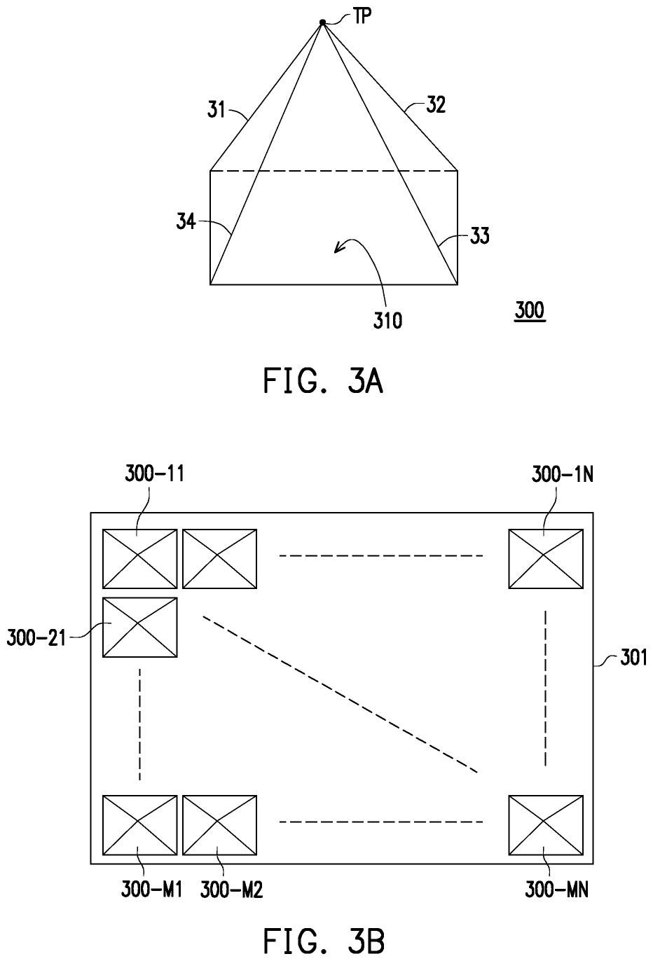

Please refer to FIG. 3A and FIG. 3B. FIG. 3A and FIG. 3B are schematic diagrams of implementing a pyramid of a prism structure according to an embodiment of the disclosure. In FIG. 3A, the prism structure may have a plurality of pyramids 300. The pyramid 300 has a rectangular bottom surface 310, a vertex TP, and a plurality of hypotenuses 31 to 34. In the embodiment, the lengths of the hypotenuses 31 to 34 may be all the same, partially the same, or all different. The vertical projection of the vertex TP on the bottom surface 310 may or may not fall on the geometric center of the bottom surface 310, and there is no fixed limit.

In other embodiments of the disclosure, the bottom surface 310 of the pyramid 300 may not be rectangular and may be any shape, such as a circle, an ellipse, or an arbitrary polygon.

FIG. 3B is a top view of the prism structure. The prism structure is disposed with a plurality of pyramids 300-11 to 300-MN arranged in an array. Each of the pyramids 300-11 to 300-MN may be designed like the pyramid 300, wherein the tilt angles of all the pyramids 300-11 to 300-MN need not be the same.

Each of the pyramids 300-11 to 300-MN is configured to converge a plurality of sub beams projected onto the prism structure and enable the beam generated by the backlight apparatus to have a light-concentrating effect.

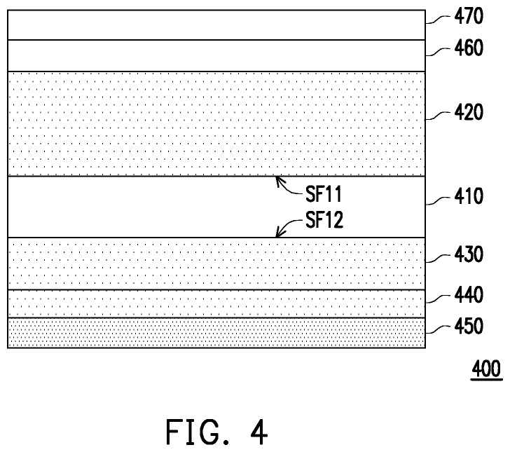

Please refer to FIG. 4. FIG. 4 is a cross-sectional structure diagram of a backlight apparatus according to another embodiment of the disclosure. A backlight apparatus 400 includes a light guiding component 410, a prism structure 420, a reflection layer 430, a flexible circuit board 440, a metal back cover 450, and a rim tape 470. In the embodiment, the light guiding component 410 and the prism structure 420 are overlapped and disposed on a first surface SF11 of the light guiding component 410. The reflection layer 430 is overlapped with a second surface SF12 of the light guiding component 410. In addition, the reflection layer 430, the flexible circuit board 440, and the metal back cover 450 are sequentially overlapped with each other.

On the other hand, the rim tape 470 covers the prism structure 420 through an air gap 460.

In the embodiment, the reflection layer 430 is configured to block the beam from escaping from the second surface SF12 of the light guiding component 410. The flexible circuit board 440 is configured to connect to a light source (such as a light emitting diode) on a side of the light guiding component 410 and to transmit a driving signal to the light source.

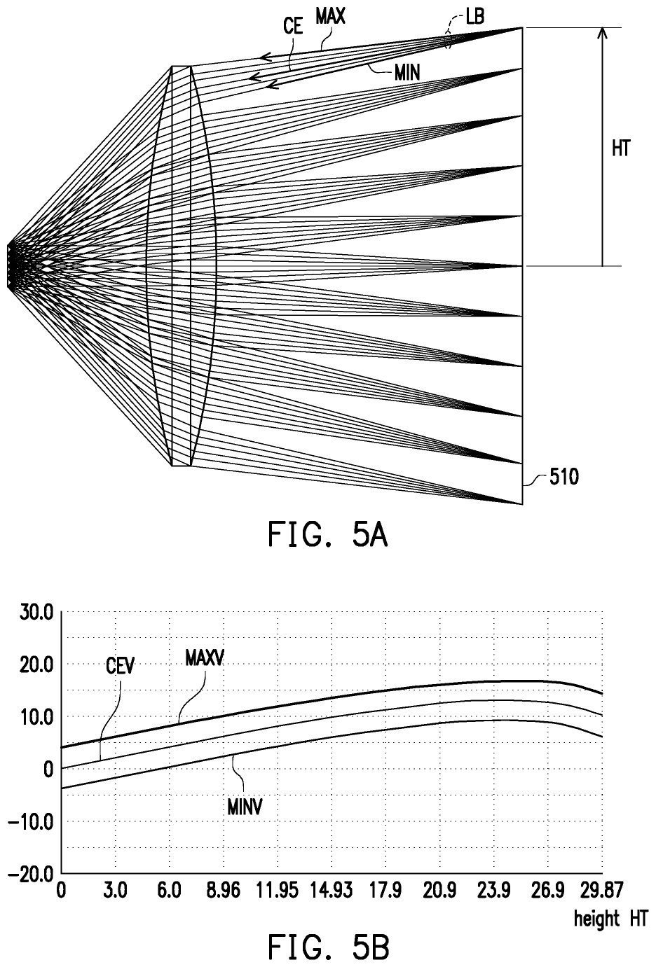

Please refer to FIG. 5A and FIG. 5B. FIG. 5A and FIG. 5B are respectively distribution diagrams of emission angles of sub beams generated by a backlight apparatus according to an embodiment of the disclosure. In FIG. 5A, in a plurality of sub beams of a plurality of beams LB provided by a backlight apparatus 510, the angle range of an emission angle CE of the sub beam at the center position, an emission angle MAX of the sub beam at the highest position, and an emission angle MIN of the sub beam at the lowest position will not exceed half of a preset reference value. In other words, through the backlight apparatus according to the embodiment of the disclosure, the emission angles of the sub beams of each beam generated by the backlight apparatus may be limited to a certain range, thereby effectively improving the light emission intensity.

In FIG. 5B, as a height HT of the position of the beam on the backlight apparatus changes, a curve CEV represents the change curve of the emission angle of the sub beam at the center position of the beam; a curve MAXV represents the change curve of the emission angle of the sub beam at the highest position of the beam; and a curve MINV represents the change curve of the emission angle of the sub beam at the lowest position of the beam. It can be clearly found from FIG. 5B that in the embodiment of the disclosure, the curve MAXV, the curve MINV, and the curve CEV are constantly distributed in a fixed range (plus or minus 5 degrees), wherein the difference between the curve MAXV and the curve MINV corresponds to an arbitrary height HT, which will not be greater than the reference value (for example, 10 degrees).

In summary, the backlight apparatus and the head mounted display device of the disclosure enable the beam generated by the backlight apparatus to have a light-concentrating effect by disposing the plurality of convex pyramids on the prism structure, thereby effectively improving the brightness of the display beam and reducing power consumption.

Although the disclosure has been disclosed in the above embodiments, the embodiments are not intended to limit the disclosure. It will be apparent to persons skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A backlight apparatus, adapted for a head mounted display device, comprising:
a light guiding component;
a light source, disposed on a side of the light guiding component; and
a prism structure, wherein the prism structure has a first surface adjacent to a first surface of the light guiding component; there are a plurality of convex pyramids on the first surface of the prism structure, and the pyramids are arranged in an array.

2. The backlight apparatus according to claim 1, wherein a plurality of beams are generated on a second surface of the prism structure, each of the beams is composed of a plurality of sub beams, and a range of emission angles of the sub beams of each of the beams is less than a reference value, wherein the second surface of the prism structure is opposite to the first surface of the prism structure.

3. The backlight apparatus according to claim 2, wherein the reference value is 10 degrees.

4. The backlight apparatus according to claim 1, wherein the pyramids are in contact with the first surface of the light guiding component.

5. The backlight apparatus according to claim 1, further comprising:
a reflection layer, having a first surface overlapped with a second surface of the light guiding component, wherein the first surface of the light guiding component is opposite to the second surface of the light guiding component.

6. The backlight apparatus according to claim 1, further comprising:
a flexible circuit board; and
a metal back cover, wherein
the reflection layer, the flexible circuit board, and the metal back cover are sequentially overlapped.

7. A head mounted display device, comprising:
a display panel;
a lens set, disposed on an outside of a first surface of the display panel; and
a backlight apparatus, disposed on an outside of a second surface of the display panel, the backlight apparatus comprising:
a light guiding component;
a light source, disposed on a side of the light guiding component; and
a prism structure, wherein the prism structure has a first surface adjacent to a first surface of the light guiding component; there are a plurality of convex pyramids on the first surface of the prism structure, and the pyramids are arranged in an array, wherein
the first surface of the display panel is opposite to the second surface of the display panel.

8. The head mounted display device according to claim 7, wherein a plurality of beams are generated on a second surface of the prism structure, each of the beams is composed of a plurality of sub beams, and a range of emission angles of the sub beams of each of the beams is less than a reference value, wherein the second surface of the prism structure is opposite to the first surface of the prism structure.

9. The head mounted display device according to claim 8, wherein the reference value is 10 degrees.

10. The head mounted display device according to claim 7, wherein the pyramids are in contact with the first surface of the light guiding component.
